(19) United States
(12) Patent Application Publication
(10) Pub. No.: US 2010/0050705 A1
(43) Pub. Date: Mar. 4, 2010

(54) LOCK FOR VENDING MACHINE

(76) Inventors: Carl Johan Hakansson, Stockholm (SE); Ola Hesselvall, Farsta (SE)

Correspondence Address: STITES & HARBISON PLLC, 1199 NORTH FAIRFAX STREET, SUITE 900, ALEXANDRIA, VA, 22314, US

(21) Appl. No.: 12/295,644

(22) PCT Filed: Apr. 2, 2007
(86) PCT No.: PCT/SE2007/050207

§ 371 Date: Jul. 2, 2009

(30) Foreign Application Priority Data
Apr. 3, 2006 (SE) 0600753-8

(51) Int. Cl. E05B 65/00

(52) U.S. Cl. 70/57

(57) ABSTRACT

Locking system for access to a vending machine, such locking system comprising: —an opening handle for guiding of a movable lock means between a locked position and an unlocked position, wherein a door on the vending machine may be opened at the unlocked position, —an identification unit for electronic identification, —an electronic blocking device that is adjustable between an inactive position where it not actuates the opening handle and where the lock not may be opened from the outside, and an active position where it actuates the opening handle such that it may be opened from the outside, wherein the identification unit controls the electronic blocking device in such a way that a positive identification controls the electronic blocking device to the active position. Furthermore is a lock arranged that may be actuated independently of the identification unit and by which the movable lock means might be guided between the locked position and the unlocked position.

### FIELD OF THE INVENTION

The invention concerns a lock for a vending machine, e.g. a parking machine, which shall be accessible for maintenance such as e.g. emptying of coins, service or filling of articles.

### BACKGROUND

Today there are many ways to pay for services and articles. At some machines paying can be done either with coins, paper money or with charge card. Common for most of these types of vending machines are that service staff regularly either is emptying the machine of coins or filling it with tickets or receipt paper or other types of articles that are provided in the machine, such as e.g. snacks or drinks. The service staff can either get access to the machine by a key or by some type of electronic identification.

One problem with providing access by a key is that if the key goes astray all concerned locks have to be replaced, which of course results in large expenses. If, on the other hand, access is given by electronic identification there is a dependency of power supply to get access to the machine.

In the patent specification U.S. Pat. No. 5,402,475 a parking machine is described that automatically communicates with the service staff to tell when something is wrong with the machine. Every machine in the system can also communicate with a central coordination unit, wherein some functions in the machine may be controlled from a remote location.

In the published patent application US 2006/0032418 a lock for an electric safe is described. The lock consists of both an electronic unit and a mechanical unit that makes it possible to open the electric safe even if the electronic system fails.

### GENERAL DESCRIPTION OF THE INVENTION

One purpose with the invention is to provide a lock system for a vending machine that both is secure, gives easy access and is accessible even in absence of current. Such a system is provided by the invention according to patent claim 1. Preferred embodiments are made clear by the dependent patent claims.

According to a first aspect the invention concerns a locking system for access to a vending machine, such locking system comprising:
an opening handle for guiding of a movable lock means between a locked position and an unlocked position, wherein a door on the vending machine can be opened in the unlocked position,
an identification unit for electronic identification,
an electronic blocking device that is adjustable between an inactive position where it not actuates the opening handle and where the lock not can be opened from the outside, and an active position where it actuates the opening handle so it can be opened from the outside, wherein the identification unit guides the electronic blocking device in such a way that a positive identification guides the electronic blocking device to the active position.

The locking system comprises also a lock that is possible to actuate independently of the identification unit and by which the movable lock means might be guided between the locked position and the unlocked position.

Preferably the lock is arranged so that it directly actuates the movable lock means. In addition it may advantageously be arranged within and in alignment with the opening handle so a key may be passed through the opening handle to enter the lock to actuation of the movable lock means. One advantage having the lock arranged within the opening handle is that it gets more difficult to access for manipulation. Except that it is located deep inside the machine it is almost impossible to drill into the lock through the opening handle because the inner ring is arranged so it in these cases rotates together with the drill, which not contributes to pull apart the inner ring.

According to a preferred embodiment the opening handle comprises an inner ring, as well as an outer sleeve that is arranged so that its rotation guides the movable lock means between a locked position and an unlocked position, as well as a locking rod, wherein the inner ring is arranged inside the outer sleeve, and wherein the locking rod is ad-stably arranged between a first position, which is equivalent to the inactive position where it is neither engaged with the outer sleeve nor with the inner ring and where the inner ring can rotate freely in relation to the outer sleeve, and a second position that corresponds to the active position where it is engaged with both the outer sleeve and the inner ring so that the inner ring only can rotate together with the outer sleeve, whereby rotation of the inner ring is transferred by the outer sleeve to the movable lock means and whereby the electronic blocking device is arranged to actuate the locking rod between the first and second position.

Alternatively, the lock can be arranged so it actuates the electronic blocking device so it is possible by means of the lock to guide the electronic blocking device to the active position by hand power.

An essential feature of the invention is therefore the locking system of the machine, which enables the service staff, if there is a need, to easy get access to the machine. The identification unit for electronic identification of authorized persons might for example be connected to the card reader of a charge card, so that an authorized person only needs to slide the card and if necessary dial a code to get access to the inside of the machine. Other types of electronic identification is however possible and many different solutions are well known to the person skilled in the art. One advantage with the method of electronic identification is that it makes it possible from the central control station to control and if necessary block the access to a specific identification unit, for example a card, without need to change lock in another machine.

An acceptable identification of an authorized person makes the machine accessible from the outside for e.g. that a, from the outside of the machine, accessible opening handle is connected to it, as described above, can be opened by a simple shaped key that might be used for several different machines. The key itself has therefore a very simple pattern and is useless without the electronic identification means, and no measures must then be taken if the key would get lost in one way or another. If the electronic identification means would get lost, it is, however, important to block access to it. Because the vending machine preferably is provided with a communication unit and a central unit it is possible to block access from a central location as soon as the means of identification is reported lost.

To avoid that an unauthorized person who gets access to an electronic identification means should get access to coins or other things in a vending machine, the access to the electronic identification means may be dependent of further safety functions. E.g. each electronic identification means may be connected to a PIN code, or the access may be limited to a certain interval of time, or the access can be dependent of identification of a user in a further way e.g. by a cellular telephone. In the case that each single vending machine not is designated to content lot of money can it however be sufficient that the service person only has to be identified by means of a regular card with a magnetic strip. If a card gets lost is it, as mentioned above, quickly done to block it. Other possible electronic identification means might be a transponder, a RFID or similar equipment. However, the type of electronic identification means that is used is not limiting the invention.

One important aspect of the invention is that it should be possible to get access to the vending machine even without using electronic identification means and without that the electronic blocking in the vending machine need to be inactivated. Thus, there shall be a mechanic lock that is not dependent of power supply. The mechanical opening function may be achieved in many different ways. One possible solution is to provide the vending machine with a separate lock that either influences the electronic blocking in such a way that it is activated so it will be possible to open the vending machine with the key with simple shape, which normally is used in combination with the electronic identification means, or directly influences the locking rail. Thus every vending machine should be provided with a mechanical lock, to which a main key exists that is stored in a secure place and that only is designated to be used when it not is possible to open the vending machine in another way, e.g. if there is no power supply to the machine. The machine is suitably provided with a battery and when it needs to be changed and some possible alternative power source also is disabled there is no other possibility to access the vending machine.

### SHORT DESCRIPTION OF THE DRAWINGS

FIG. 1 shows a schematic drawing of a vending machine, (see page 9 for reference numbers),

FIG. 2 shows an exploded view of an embodiment of the locking system according to the invention, (see page 9 for reference numbers),

FIG. 3 shows a side view of an embodiment of the locking system according to the invention,

FIG. 4 shows a view of an embodiment of the locking system along the line B-B in FIG. 6,

FIG. 5 shows an enlarged view of the selected area in FIG. 4, and

FIG. 6 shows a schematic drawing of a vending machine.

### DESCRIPTION OF A PREFERRED EMBODIMENT OF THE INVENTION

Below a preferred embodiment of the invention will be described.

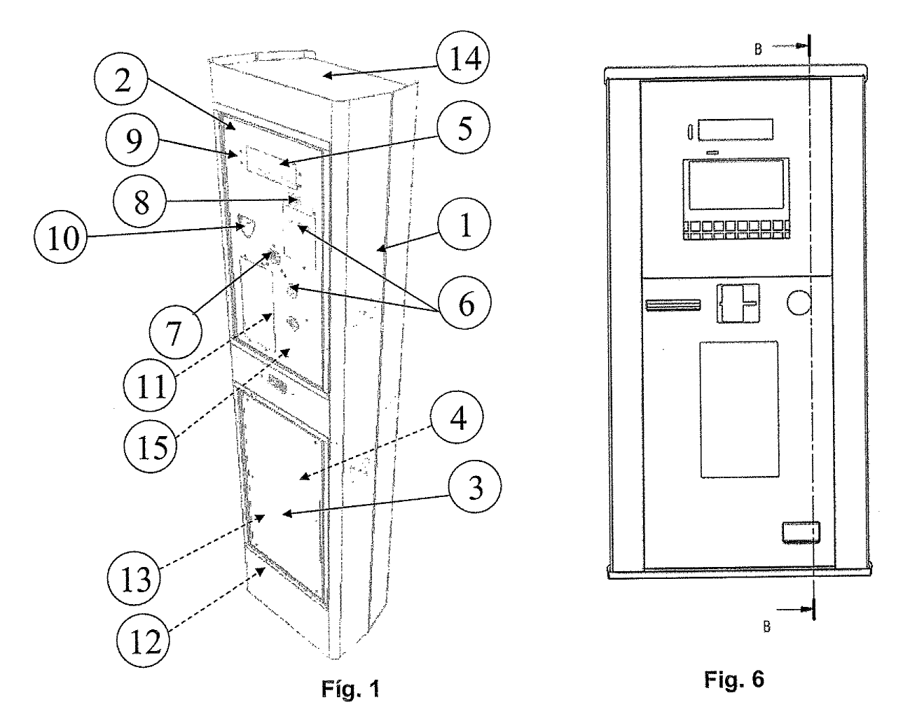

In FIG. 1 (see page 9 for reference numbers) is shown a schematic drawing of an embodiment of the vending machine according to the invention. The vending machine has both a slot for paying with coins and a card reader for paying with card. Furthermore the machine is provided with a central unit for guiding of different units in the machine. Preferably it has also a printer for printing of receipts or tickets, and a communication unit for communication with a central control station.

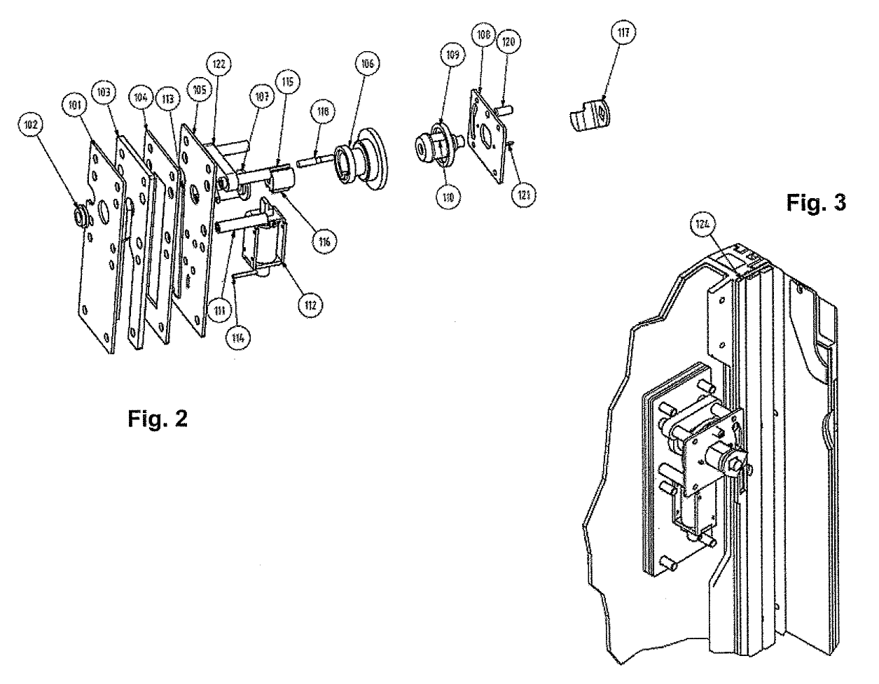

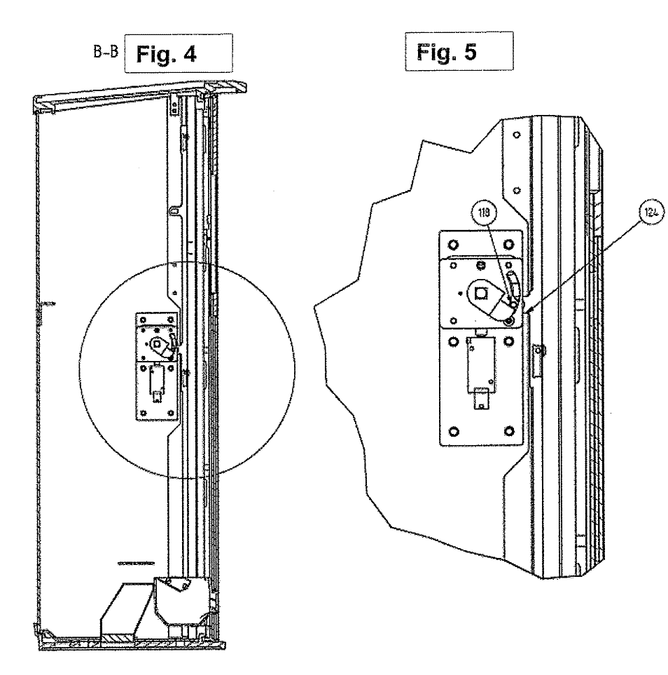

FIG. 2 (see page 9 for reference numbers) shows an exploded view of the locking system according to the invention. Next to the outside of the pay terminal is an outer sheet 101 arranged. In the outer sheet a protection of drilling 102 is arranged, through which a key shall pass to unlock the lock and open the machine. Inside the outer sheet there is arranged in order, an intermediate sheet 103, a door guide 104 and an inner sheet. A door 113, which at least partly is preventing access to the key hole, is arranged to slide in a rectangular opening in the door guide 104. This door is automatically opened when correct identification of an authorized operator is done, which will be described in detail below. The door 113 is however optional and might be omitted, since no block actually is necessary to prevent that keys and similar things can be inserted in the inner ring 115. The inner ring is actually disconnected from the rest of the lock before correct identification has been done, so it can rotate freely without actuation of the opening function of the lock. To actuate the locking rail 124, which is the part that keeps the door of the machine closed, the outer sleeve 106, which is arranged outside the inner ring, must actually be turned.

When the service staff wants to get access to the inside of the machine they are accordingly starting by undertaking an electronic identification. The identification may, as mentioned above, be performed in many different ways, e.g. the machine can be designed in such a way that it is sufficient to slide a plastic card with some sort of magnetic strip in the card reader of the machine. Once the identification is done the operator may enter a key (not shown) through the protection of drilling 102 and an outer support 107. The key is then slid into, and is engaged with the inner ring 115.

A blocking device is arranged to get the inner ring engaged with the outer sleeve. When an authorized operator has identified himself the blocking device is activated and it is possible to unlock the lock with the key. The blocking device comprises a bolt that is arranged inside a solenoid 112. At a correct identification current is applied to the solenoid pushing the bolt upwards against a locking rod 116. The movement of the bolt is also guiding a door rod 114, which is connected to the door 113, to guide this rod upwards so the key hole can be directly accessible from the outside. Meanwhile the upper side of the bolt is guiding the first locking rod 116. At the locked position, the first locking rod 116 is arranged in a slot in the outer sleeve 106 without contact with the inner ring 115, but when the bolt is pushed upwards the first locking rod 116 is positioned between the inner ring 115 and the outer sleeve 106, wherein any possible turning of the inner ring 115 is transmitted to the outer sleeve 106. The outer sleeve 106 is also firmly attached to a second locking rod 118, which extends through a hole (not shown) positioned in the largest diameter of the outer sleeve 106. The second locking rod 118 is anchored in the locking rail 124 (see FIG. 3) and moves it upwards to an opened position. Instead of a locking rail a locking bolt or some other type of lock means known to the person skilled in the art might be used. The invention is therefore not limited to locks with a guide rail.

Behind the inner ring 115 and the outer sleeve 106 is a lock 110 arranged. The lock 110 is arranged in alignment with the inner ring 115 and is accessible by sliding a long and narrow main key through the inner ring 115. The lock 110, which is a safety lock and to which it preferably only exists one key that is kept in a secure place, is only intended to be used in case of emergency, when the opening handle because of some reason is disabled. The lock 110 is guiding a turn sheet 117 that is protected behind a back sheet 108. The turn sheet is arranged in engagement with the extension of the second locking rod 118 such that it by this turn sheet can guide the locking rail 124 to an opened position.

It is of course possible to arrange the engagement of the lock with the locking rail in other ways. It is e.g. not necessary that it actuates the same locking rod 118, which is actuated by the opening handle. Instead it might e.g. be arranged so it directly actuates the locking rail 124.

### REFERENCE NUMBERS TO FIG. 1

1. Housing (may be divisible) with possible lightning
2. Upper door with lock
3. Possible lower door with lock
4. Possible door for coin box inside lower door with lock
5. Display (-s)
6. Operating buttons or touch screen
7. Coin/Paper money reader with return/change and box
8. Card reader (proxy, magnet, chip etc)
9. Indications (LED, lamps)
10. Possible printer
11. Control card with CPU and network
12. Battery
13. Battery charger and possible power supply
14. Possible solar panel
15. Communication modem with possible aerial

### REFERENCE NUMBERS TO FIG. 2

101. Outer sheet
102. Protection of drilling
103. Intermediate sheet
104. Door guide
105. Inner sheet
106. Outer sleeve
107. Outer support
108. Back sheet
109. Inner support
110. Lock Abloy
111. Distance sleeve
112. Solenoid Kuhnke
113. Door
114. Door rod
115. Inner ring
116. Locking rod
117. Turn sheet
118. Locking rod
120. Thrust screw GN615 M6
121. Resilient tension pin FRP 2×8
123. Recessed head screw MFX 4×6

1. Locking system for access to a vending machine, such locking system comprising:
an opening handle (106, 115, 116) for guiding of a movable lock means (124) between a locked position and an unlocked position, wherein a door on the vending machine may be opened at the unlocked position,
an identification unit for electronic identification,
an electronic blocking device (111, 112) that is adjustable between an inactive position where it not actuates the opening handle (106, 115, 116) and where the lock not may be opened from the outside, and an active position where it actuates the opening handle (106, 115, 116) such that it may be opened from the outside, wherein the identification unit controls the electronic blocking device (111, 112) in such a way that a positive identification controls the electronic blocking device to the active position,
a lock (110) that may be actuated independently of the identification unit and by which the movable lock means (124) might be guided between the locked position and the unlocked position, wherein the lock (110) is arranged within and in alignment with the opening handle (106, 115, 116) such that a key may pass through the opening handle (106, 115, 116) to enter the lock to actuate the movable lock means (124),
characterized in that the opening handle comprises an inner ring (115), an outer sleeve (106) that is arranged so that its rotation guides the movable lock means (124) between a locked position and an unlocked position, and a locking rod (116), wherein the inner ring (115) is arranged inside the outer sleeve (106), and wherein the locking rod (116) is adjustably arranged between a first position, which is equivalent to the inactive position where it is neither engaged with the outer sleeve (106) nor with the inner ring (115) and where the inner ring may rotate freely in relation to the outer sleeve (106), and a second position that is equivalent to the active position where it is engaged with both the outer sleeve (106) and the inner ring (115) so that the inner ring only may rotate together with the outer sleeve, whereby rotation of the inner ring (115) is transferred from the inner ring (115) by the outer sleeve (106) to the movable lock means (124) and whereby the electronic blocking device is arranged to actuate the locking rod (116) between the first and second position.

2. Locking system according to claim 1, characterized in that the lock (110) is arranged so it directly actuates the movable lock means (124).

3. Locking system according to claim 1, characterized in that the lock is arranged to actuate the electronic blocking device, by means of the lock, to manually position the electronic blocking device (112) in the active position.
